(19) United States
(12) Patent Application Publication
(10) Pub. No.: US 2016/0248817 A1
(43) Pub. Date: Aug. 25, 2016

(54) SYSTEMS AND METHODS FOR SETTING UP A TELEPHONY COMMUNICATION

(71) Applicant: VONAGE NETWORK, LLC, Holmdel, NJ (US)

(72) Inventors: EUGENE PETER CANNON, RED BANK, NJ (US); BRYAN STOKES, HILLSBOROUGH, NJ (US); BERNARD SCHULZ, RED BANK, NJ (US)

(21) Appl. No.: 14/627,684

(22) Filed: Feb. 20, 2015

(51) Int. Cl. H04L 29/06; H04M 7/00; H04M 3/42; H04W 76/04

(52) U.S. Cl. CPC H04L 65/1069; H04L 65/80; H04W 76/04; H04M 7/006; H04M 3/42059

(57) ABSTRACT

When an Internet Protocol (IP) telephony system receives a telephony communication setup request for a user of the IP telephony system, the IP telephony system attempts to setup the new telephony communication to the user's telephony device as an IP telephony communication that traverses a data network. However, if the called party wishes to instead setup the new telephony communication through an alternate telephony system, such as a cellular telephony system, the IP telephony system acts to facilitate the setup of the new telephony communication via that alternate telephony system. This could include placing a telephone call to the user's telephony device via the alternate telephony system, or receiving an incoming call from the user's telephony device that is received via the alternate telephony system.

### BACKGROUND OF THE INVENTION

The invention is related to Internet Protocol (IP) telephony systems. More specifically, the invention is related to systems and methods for setting up a new telephony communication to a user telephony device.

When an IP telephony system receives an incoming telephony communication setup request for one of its users, the IP telephony system typically attempts to setup the new telephony communication as an IP telephony communication that traverses a data network. This means sending an IP telephony communication setup request to one or more of the user's IP telephony devices via a data network. If the user's IP telephony device signals that it is able and willing to setup the new telephony communication via a return communication, the new telephony communication can be setup to the user's IP telephony device as an IP telephony communication that traverses the data network.

In some instances, however, even when the user's IP telephony device is capable of setting up the telephony communication as an IP telephony communication over a data network, the user may choose to decline the new telephony communication. For example, if the user's IP telephony device is a smartphone that is running an IP telephony software application, the smartphone is likely connected to the data network via a wireless data connection that has been established between the user's smartphone and a wireless access point, such as a wireless router. If a new incoming telephony communication setup request is received at a point in time when the user is just about to physically move out of range of the wireless access point, the user may choose to decline the new telephony communication, rather than accept the telephony communication and then be prevented from moving away from the wireless access point until the telephony communication can be completed.

In another example, the user may know that the data transmission speed provided by the smartphone's wireless data connection to the wireless access point is likely to be too slow or unstable to support a telephony communication that has high quality. In that instance, the user may choose to decline the incoming telephony communication, rather than conduct a poor quality telephony communication.

In those instances where a user does not wish to setup the new incoming telephony communication as an IP telephony communication that traverses the data network, it would be desirable for the user to have the option of causing the telephony communication to be setup via an alternate path, or via an alternate telephony service provider. In yet other instances, it would be desirable for the user to have the option of causing the telephony communication to be setup to a telephony device other than the one which received the initial IP telephony communication setup request from the IP telephony system.

### BRIEF DESCRIPTION OF THE DRAWINGS

FIG. 1 is a diagram of a communications environment including various elements which are associated with an Internet protocol (IP) telephony system operating in accordance with an embodiment of the invention;

FIG. 2 is a diagram of various elements of a processor that forms part of an IP telephony system and/or part of a user's telephony device;

FIG. 3 is a more detailed diagram of a communications environment that is used to explain how a telephony communication is setup between a calling party's telephony device and a telephony device used by a called party;

FIG. 4 is a block diagram illustrating selected elements of an IP telephony system;

FIG. 5 is a block diagram illustrating selected elements of a user's IP telephony device;

FIG. 6 is a diagram illustrating selected elements of a user's telephony device that is capable of loading and running an IP telephony software application;

FIG. 7 is a flow diagram illustrating steps of a first method performed by elements of an IP telephony system to setup a new telephony communication for a user of the IP telephony system;

FIG. 8 is a flow diagram illustrating steps of a second method performed by elements of an IP telephony system to setup a new telephony communication for a user of the IP telephony system;

FIG. 9 is a flow diagram illustrating steps of a third method performed by elements of an IP telephony system to setup a new telephony communication for a user of the IP telephony system;

FIG. 10 is a flow diagram illustrating steps of a fourth method performed by elements of an IP telephony system to setup a new telephony communication for a user of the IP telephony system;

FIG. 11 is a flow diagram illustrating steps of a first method performed by elements of a user's telephony device or elements of an IP telephony software application running on a user's telephony device to facilitate the setup of a new telephony communication;

FIG. 12 is a flow diagram illustrating steps of a second method performed by elements of a user's telephony device or elements of an IP telephony software application running on a user's telephony device to facilitate the setup of a new telephony communication; and

FIG. 13 is a flow diagram illustrating steps of a third method performed by elements of a user's telephony device or elements of an IP telephony software application running on a user's telephony device to facilitate the setup of a new telephony communication.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

In the following description, the terms VOIP system, VOIP telephony system, IP system and IP telephony system are all intended to refer to a system that connects callers and that delivers data, text or video communications using Internet protocol data communications.

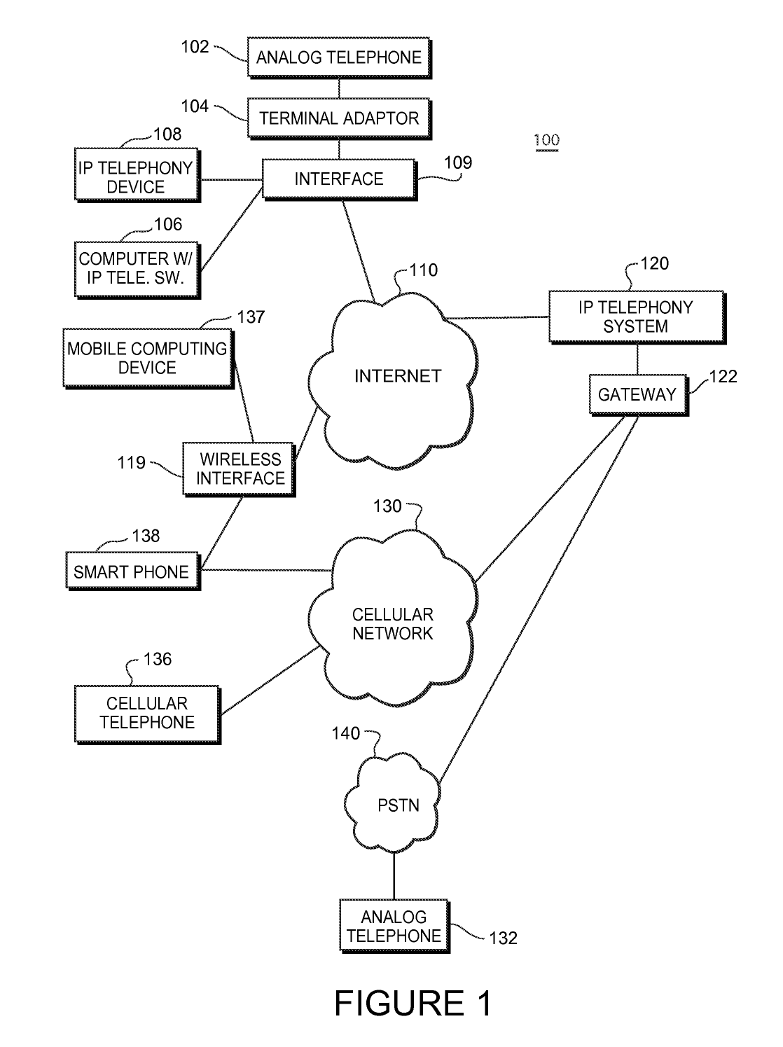

As illustrated in FIG. 1, a communications environment 100 is provided to facilitate IP based communications. An IP telephony system 120 enables connection of telephone calls between its own customers and other parties via data communications that pass over a data network. The data network is commonly the Internet 110, however, private data networks may form all or a portion of the data communication path. The IP telephony system 120 is connected to the Internet 110. In addition, the IP telephony system 120 is connected to both a publicly switched telephone network (PSTN) 140 and a cellular telephony network 130 via one or more gateways 122.

The gateway 122 allows users and devices that are connected to the PSTN 140 and cellular network 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephony device 108 that is connected to the Internet 110 via an interface 109. Such an IP telephony device 108 could be connected to an Internet service provider via a wired connection or via a wireless router.

Alternatively, a customer could utilize a normal analog telephone 102 which is connected to the Internet 110 via a terminal adapter 104 and the interface 109. The terminal adapter 104 converts analog signals from the telephone 102 into digital data signals that pass over the Internet 110, and vice versa. Analog telephony devices include, but are not limited to, standard telephones and document imaging devices such as facsimile machines.

In addition, a customer could utilize a soft-phone client running on a computer 106 to place and receive IP based telephone calls, and to access other IP telephony systems (not shown). In some instances, the soft-phone client could be assigned its own telephone number. In other instances, the soft-phone client could be associated with a telephone number that is also assigned to an IP telephone 108, or to a terminal adaptor 104 that is connected to one or more analog telephones 102.

Likewise, a mobile computing device 137 may be used to send and receive telephony communications via the IP telephony system 120. The mobile computing device 137 could establish a data connection to the Internet 110 via a wireless interface 119, such as a WiFi router. IP telephony software on the mobile computing device 137 could then be used to conduct telephony communications through the IP telephony system 120.

A third party using an analog telephone 132 which is connected to the PSTN 140 may call a customer of the IP telephony system 120. In this instance, the call is initially connected from the analog telephone 132 to the PSTN 140, and then from the PSTN 140, through the gateway 122 to the IP telephony system 120. The IP telephony system 120 then routes the call to the customer's IP telephony device. Likewise, a third party using a cellular telephone 136 could also place a call to an IP telephony system customer, and the connection would be established in a similar manner, although the first link would involve communications between the cellular telephone 136 and a cellular telephony network 130.

In addition, a smartphone 138 that includes both mobile computing capabilities and cellular telephony capabilities can connect to the cellular network 130 using its cellular telephone capabilities. However, the smartphone 138 also may establish a data connection to the IP telephony system 120 via a wireless interface 119 and the Internet 110. In this instance, communications between the smartphone 138 and other parties could be entirely carried by data communications. Of course, alternate embodiments could utilize any other form of wired or wireless communications path to enable communications.

Users of the first IP telephony system 120 are able to access the service from virtually any location where they can connect to the Internet 110. Thus, a customer could register with an IP telephony system provider in the U.S., and that customer could then use an IP telephony device 108 located in a country outside the U.S. to access the services. Likewise, the customer could also utilize a computer with IP telephony software 106 or a mobile computing device with IP telephony software 137 outside the U.S. to access the IP telephony system 120. Further, in some instances a user could place a telephone call with the analog telephone 132 or the cellular telephone 136 that is routed through the PSTN 140 or cellular network 130, respectively, to the IP telephony system 120 via the gateway 122. This would typically be accomplished by the user calling a local telephone number that is routed to the IP telephony system 120 via the gateway 122. Once connected to the IP telephony system 120, the user may then place an outgoing long distance call to anywhere in the world using the IP telephony system's network. Thus, the user is able place a long distance call using lower cost IP telephony service provided by the IP telephony system 120, rather than a higher cost service provided by the PSTN 140 or cellular network 130.

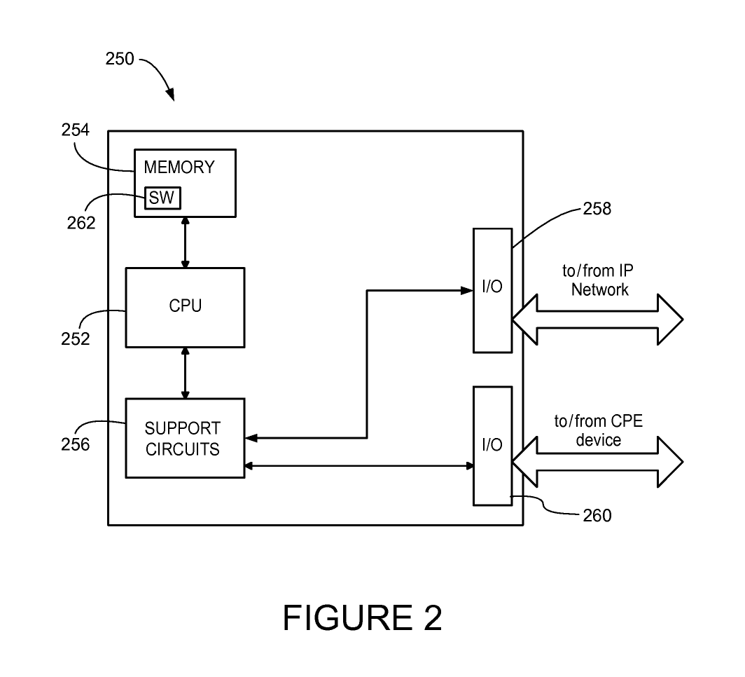

FIG. 2 illustrates elements of a computer processor 250 that can be used as part of the IP telephony system 120, or as part of a user's telephony device, to accomplish various functions. The IP telephony system 120 could include multiple processors 250 located at various locations in the system, along with their operating components and programming, each carrying out a specific or dedicated portion of the functions performed by the IP telephony system 120. Likewise, a user's telephony device could include one or more processors 250, along with their operating components and programming, each carrying out a specific or dedicated portion of the functions performed by the telephony device.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment, to service provider equipment, to and IP network or gateways, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of the IP telephony system 120 and/or a user's telephony device. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

In the following description, references will be made to an “IP telephony device.” This term is used to refer to any type of device which is capable of interacting with an IP telephony system to conduct or participate in an IP telephony communication. An IP telephony device could be an IP telephone, a computer running IP telephony software, a telephone adaptor which is connected to an analog telephone, or some other type of device capable of communicating via data packets. An IP telephony device could also be a cellular telephone, a smartphone, or a portable or tablet computing device that runs a software client that enables the device to act as an IP telephony device. Thus, a single device might be capable of operating as both a cellular telephone and an IP telephony device.

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod touch™, which includes a speaker and a microphone. A software application loaded onto an Apple iPod touch™ can be run so that the Apple iPod touch can interact with an IP telephony system to conduct a telephone call.

The following description will also refer to telephony communications and telephony activity. These terms are intended to encompass all types of telephony communications, regardless of whether all or a portion of the communications are carried in an analog or digital format. Telephony communications could include audio or video telephone calls, facsimile transmissions, text messages, SMS messages, MMS messages, video messages, and all other types of telephony and data communications sent by or received by a user. These terms are also intended to encompass data communications that are conveyed through a PSTN or VOIP telephony system. In other words, these terms are intended to encompass any communications whatsoever, in any format, which traverse all or a portion of a communications network or telephony network.

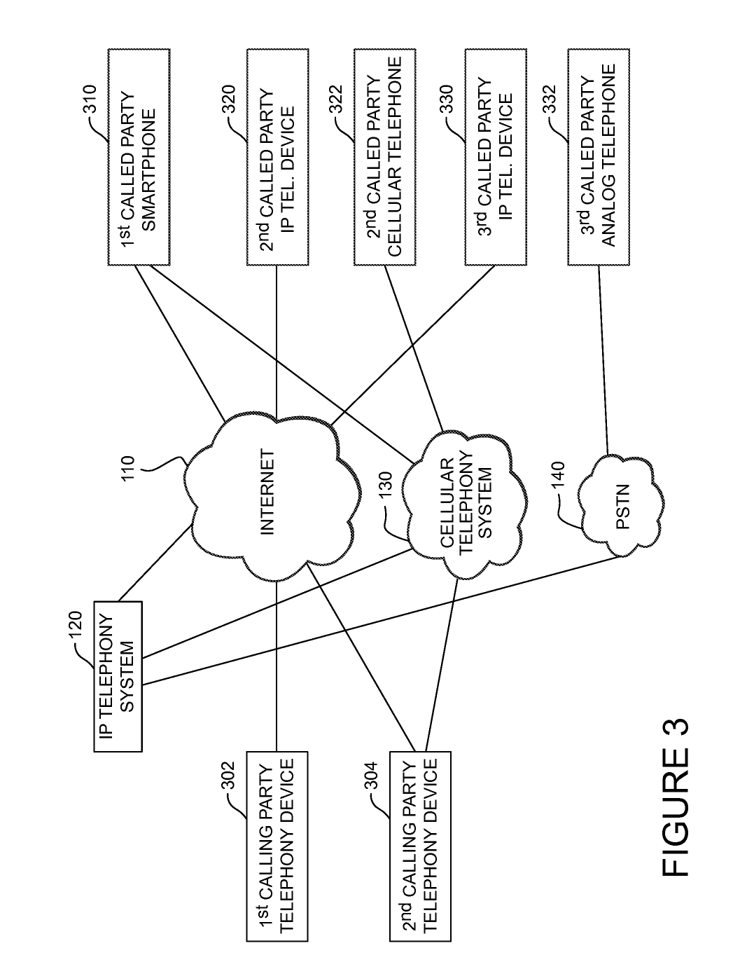

As explained above, when an IP telephony system 120 receives a telephony communication setup request directed to one of its users, the IP telephony system 120 will typically send a communication to one or more of the user's IP telephony devices seeking to setup the requested telephony communication. In some instances, however, the user may prefer that the telephony communication not be established as an IP telephony communication that traverses a data network. The communications environment 300 illustrated in FIG. 3 will be used to provide an explanation of some alternative ways that the telephony communication could be established via an alternate telephony system, and possibly to an alternate telephony device.

FIG. 3 illustrates that an IP telephony system 120 is connected to a data network, such as the Internet 110. A cellular telephony system 130 and a PSTN 140 are also capable of handling the setup and carrying of telephony communications. The IP telephony system 120 is connected to the cellular telephony system 130 and the PSTN 140 either directly, or via one more gateways, as illustrated in FIG. 1.

A first calling party's telephony device 302 is an IP telephony device that is also coupled to the Internet 110. The connection between the first calling party's telephony device 302 and the Internet 110 could be accomplished via a wireless access point, such as a wireless router, or via other means.

A second calling party's telephony device 304 is a dual mode device. The second party's telephony device 304 is capable of establishing a call via the cellular telephony system 130. The second party's telephony device 304 is also capable of setting up IP telephony communications via the Internet 110 using one or more IP telephony service providers. Examples of the second party's telephony device 304 include smartphones, and portable computing devices that include cellular capabilities and wireless data capabilities.

A first called party's smartphone 310 is also a dual mode device. The first called party's smartphone 310 can setup cellular telephony communications via a cellular link to the cellular telephony system 130. The first called party's smartphone 310 is also capable of setting up IP telephony communications via the Internet 110, using the IP telephony system 120. Typically, an IP telephony software application provided by the IP telephony system 120 would be loaded and run on the first called party's smartphone 310 to convert the smartphone 310 into an IP telephony device that is capable of conducting IP telephony communications via the Internet 110, with the assistance of the IP telephony system 120.

Because the first called party's telephony device 310 is a dual mode device, there may be two or more telephone numbers assigned to the first called party's smartphone 310. A first telephone number would be assigned by the cellular telephony system 130 that provides the first called party's smartphone 310 with its native telephony service. A second telephone number would be assigned by the IP telephony system 120. That second telephone number would be associated with the IP telephony software application that is loaded and run on the first called party's smartphone 310.

When a party dials the first telephone number assigned by the cellular telephony system 130, a call setup request from the calling party is received by the cellular telephony system 130, and the cellular telephony system 130 attempts to setup a cellular telephony communication to the first called party's smartphone 310. When a party dials the second telephone number assigned by the IP telephony system 120, the call setup request is received by the IP telephony system 120, and the IP telephony system 120 attempts to setup an IP telephony communication with the IP telephony software application on the first called party's smartphone 310.

In systems and methods embodying the invention, when a user of the first calling party telephony device 302 dials the second telephone number assigned to the first called party's smartphone 310, the IP telephony system 120 receives a telephony communication setup request directed to that second telephone number. The IP telephony system 120 then sends an IP telephony communication setup request to the IP telephony software application running on the first called party's smartphone 310 via the Internet 110. The IP telephony software application causes a query to be displayed to the first called party. The query asks the first called party if the first called party would like to setup the requested telephony communication as an IP telephony communication that traverses the Internet 110, if the first called party would like to decline the telephony communication, or if the first called party would like to setup the telephony communication via an alternate telephony system.

If the first called party instructs the IP telephony software application to setup the telephony communication via an alternate telephony system, this setup attempt could be made in various different ways, as will be explained in detail below. In some instances, the IP telephony software application could signal the IP telephony system 120 to call the first called party's smartphone via the cellular telephony system 130. For example, the IP telephony system 120 could place an outgoing telephone call to the first telephone number assigned to the called party's smartphone 310, and that outgoing call would be routed to the first called party's smartphone via the cellular telephony system 130. Assuming the first called party answers that incoming cellular based call, the IP telephony system 120 then bridges the incoming call received from the first calling party's telephony device 302 to the outgoing call placed to the first telephone number assigned to the first called party's smartphone 310, and the requested telephony communication will be established to the first called party's smartphone 310 via the connection provided by the cellular telephony system 130.

In alternate embodiments, the IP telephony communication setup request that is sent from the IP telephony system 120 to the IP telephony software application running on the first called party's smartphone 310 could include an access telephone number that is maintained by the IP telephony system 120. In this instance, when the user indicates that the telephony communication is to be setup via an alternate telephony system, the IP telephony software application could cause a native cellular unit of the smartphone 310 to dial the access telephone number provided in the IP telephony communication setup request. The outgoing call would be routed through the cellular telephony system 130 to the IP telephony system 120. The IP telephony system 120 answers the incoming call, which would be received on a line corresponding to the access telephone number. The IP telephony system 120 could check the caller ID information associated with the incoming call to determine that the call is being received from the first called party's smartphone 310. In which case, the IP telephone system 120 bridges the incoming call from the first called party's smartphone 310 to the incoming call received from the first calling party's telephony device 302. In this embodiment, the telephony communication established between the first calling party's telephony device 302 and the first called party's smartphone 310 also would be connected to the first called party's smartphone 310 via the cellular telephony system 130.

In the foregoing examples, the requested telephony communication is ultimately connected to the same called party telephony device that received the initial IP telephony communication setup request from the IP telephony system, albeit though an alternate telephony system. In alternate embodiments, it is possible for the telephony communication to be setup through an alternate telephony system, and for the telephony communication also to be setup to an alternate telephony device.

For example, assume that a user of the second calling party telephony device 304 requests the setup of a new telephony communication to the second called party's IP telephony device 320. This would typically be done by causing a telephone call to be placed to a telephone number associated with the second called party's IP telephony device 320. That telephony communication setup request would initially be received by the IP telephony system 120. The IP telephony system 120 then sends an IP telephony communication setup request to the second called party's IP telephony device 320 via the Internet 110.

The second called party's IP telephony device 320 then causes a query to be presented to the second called party, the query asking if the requested telephony communication should be setup as an IP telephony communication that traverses the Internet 110, if the second called party would like to decline the telephony communication, or if the second called party would like to have the telephony communication setup via an alternate telephony system to an alternate telephony device, such as the second called party's cellular telephone 322.

If the second called party asks to have the telephony communication setup via an alternate telephony system to an alternate telephony device, the second called party's IP telephony device 320 communicates this information back to the IP telephony system 120. In some instances, this communication could include an identification of the alternate telephony device to which the telephony communication is to be established, which in this case is the second called party's cellular telephone 322. In other instances, the IP telephony system 120 may be pre-configured to establish the telephony communication to a default alternate telephony device for the second called party, which again would be the second called party's cellular telephone 322.

The IP telephony system 120 then places an outgoing telephone call to the second called party's cellular telephony 322. The outgoing telephone call would be established via the cellular telephony system 130, which provides the second called party's cellular telephone 322 with its native telephony service. The IP telephony system 120 then bridges the incoming call received from the second calling party's telephony device 304 to the outgoing call placed to the second called party's cellular telephone 322.

A very similar process could occur when the second calling party's telephony device 304 requests the setup of a telephony communication with the third called party's IP telephony device 330. In this instance, if the third called party asks for the telephony communication to be setup to the third party's analog telephone 332, the IP telephony system 120 would place an outgoing call to the third called party's analog telephone 332, via the PSTN 140, and the IP telephony system 120 would bridge that outgoing call to the incoming call it received from the second calling party's telephony device 304.

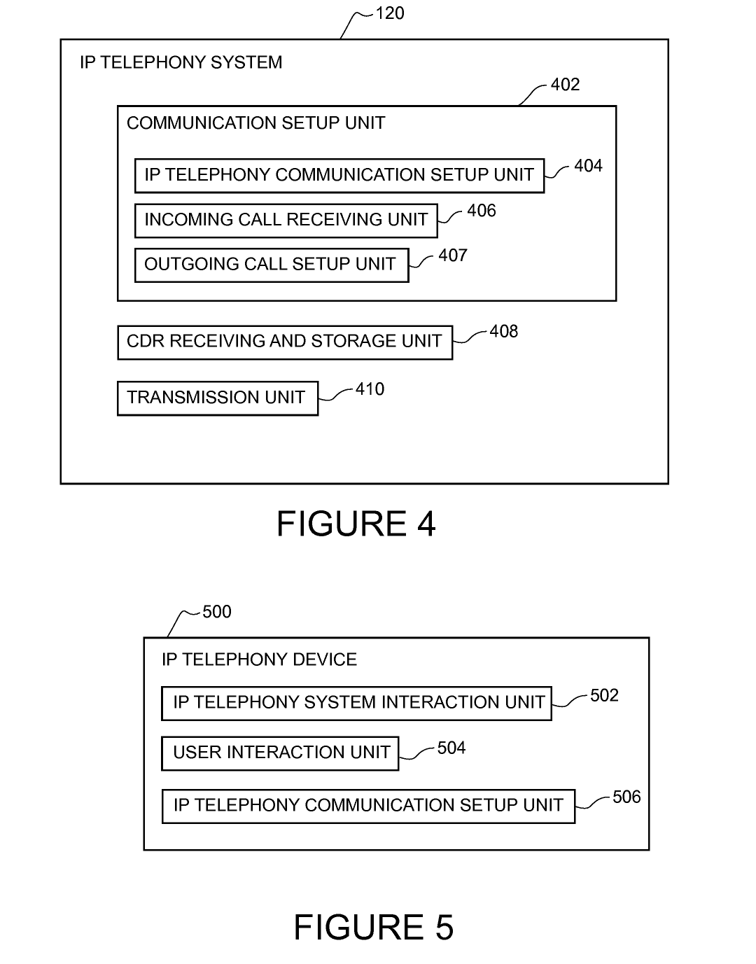

With the foregoing overview in mind, a description of the elements that make these methods possible will now be provided in conjunction with FIGS. 4-6.

FIG. 4 illustrates selected elements of an IP telephony system 120 that is capable of causing a telephony communication to be established to a called party's telephony device via an alternate telephony system. The IP telephony system 120 includes a communication setup unit 402 that is responsible for setting up telephony communications for it users. The communication setup unit 402 includes an IP telephony communication setup unit 404 that is capable of setting up IP telephony communications to the IP telephony devices of its members via one or more data networks.

An incoming call receiving unit 406 is configured to receive incoming calls from user telephony devices that are directed to special access telephone numbers. Those incoming telephone calls can be received from alternate telephony systems, such as cellular telephony systems and analog PSTN systems. The incoming call receiving unit 406 may also receive caller ID information that can be used to identify the user telephony device from which an incoming telephone call is received.

The communication setup unit 402 also includes an outgoing call setup unit 407 that sets up outgoing calls to user telephony devices via alternate telephony systems. The alternate telephony systems could include cellular telephony systems and analog PSTN systems.

The IP telephony system 120 also includes a call detail record (CDR) receiving and storage unit 408 that received CDRs from multiple different elements, and which stores the received CDRs. A billing unit 410 of the IP telephony system 120 then uses the information in the CDRs that are stored by the CDR receiving and storage unit 408 to bill users and other telephony systems for the services it provides.

An IP telephony system 120 embodying the invention will likely include many other elements in addition to those illustrated in FIG. 4. In addition, in some embodiments, an IP telephony system may not include all of the individual elements illustrated in FIG. 4. Thus, the depiction provided in FIG. 4 should in no way be considered limiting.

FIG. 5 illustrates selected elements of an IP telephony device 500 embodying the invention. The IP telephony device 500 includes an IP telephony system interaction unit 502 that is responsible for interacting with an IP telephony system like the one illustrated in FIG. 4. These interactions could be to inform the IP telephony system about how to setup a requested telephony communication, as explained above in connection with FIG. 3. For example, the IP telephony system interaction unit 502 could be responsible for instructing the IP telephony system to setup telephony communications through alternate telephony devices and over alternate telephony systems, as also described above in connection with FIG. 3.

The IP telephony device 500 also includes a user interaction unit 504. The user interaction unit 504 is capable of posing queries to the user, and of receiving user input that is made in response those queries. The user interaction unit 504 could make use of one or more displays, an audio interface that includes a speaker and a microphone, and one or more user input devices such as keyboards, touchscreens and pointing devices in order to pose queries to a user and to receive user input. The user interaction unit 504 may also make use of text-to-speech capabilities and speech recognition capabilities to pose queries to users, and to receive and interpret input from users.

The IP telephony device 500 also includes an IP telephony communication setup unit 506 that is capable of setting up IP telephony communications with the IP telephony system via a data network. The IP telephony communication setup unit 506 may operate independently from the IP telephony system interacting unit 502, or in conjunction with the IP telephony system interaction unit 502 to setup IP telephony communications for the user of the IP telephony device 500.

An IP telephony device would likely include additional elements beyond those illustrated in FIG. 5. In addition, some IP telephony devices embodying the invention may not include all of the elements illustrated in FIG. 5. Thus, the depiction provided in FIG. 5 should in no way be considered limiting.

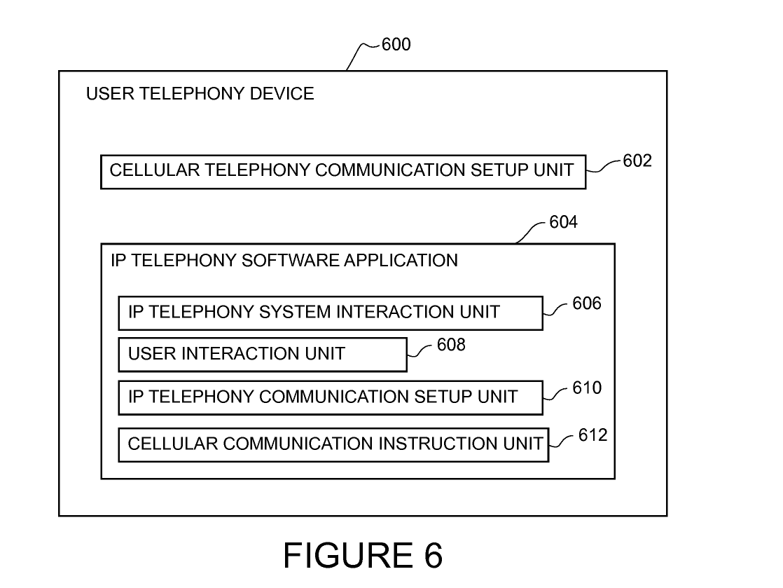

FIG. 6 illustrates selected elements of a user telephony device 600 embodying the invention. The user telephony device 600 includes a cellular telephony communication setup unit 602 that is responsible for setting up cellular telephony communications with elements of a cellular telephony system. This can include incoming cellular telephony communications and outgoing cellular telephony communications.

The user telephony device 600 also includes an IP telephony software application 604 that is loaded and run on the user telephony device 600. The IP telephony software application 604 includes an IP telephony system interaction unit 606 that interacts with elements of an IP telephony system via data communications that traverse a data network, such as the Internet. The IP telephony system interaction unit 606 can accomplish various functions such as registering the IP telephony software application with an IP telephony system, receiving and processing requests for the setup of new IP telephony communications, and instructing the IP telephony system about how a new telephony communication is to be handled, as mentioned above in connection with FIG. 3.

The IP telephony software application also includes a user interaction unit 608. The user interaction unit 608 is capable of posing queries to the user, and of receiving user input that is made in response those queries. The under interaction unit 608 could make use of one or more displays, an audio interface that includes a speaker and a microphone, and one or more user input devices such as keyboards, touchscreens and pointing devices in order to pose queries to a user and to receive user input. The user interaction unit 608 may also make use of text-to-speech capabilities and speech recognition capabilities to pose queries to users, and to receive and interpret input from users.

The IP telephony software application further includes an IP telephony communication setup unit 610 which is responsible for setting up new IP telephony communications in conjunction with elements of an IP telephony system. Also, a cellular communication instruction unit 612 is configured to cause the cellular telephony communication setup unit 602 to setup a new cellular telephony communication for the user telephony device 600.

A user telephony device that embodies the invention will likely include additional elements and features beyond those illustrated in FIG. 6. For example, the telephony device could include an operating system that allows a software application to be run on the telephony device. Also, a user telephony device may include fewer that all of the features illustrated in FIG. 6. Thus, the depiction in FIG. 6 should in no way be considered limiting.

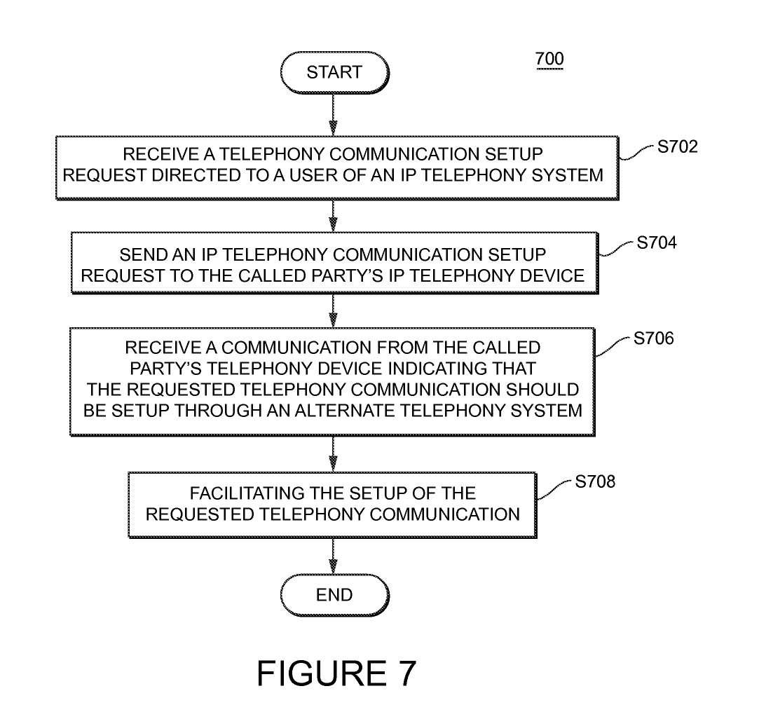

Various different methods that embody the invention and which would be performed by elements of an IP telephony system will now be described with reference to the flow diagrams in FIGS. 7-10. These descriptions may also make reference to the elements of an IP telephony system as illustrated in FIG. 4, the elements of an IP telephony device as illustrated in FIG. 5, and/or the elements of a user telephony device as illustrated in FIG. 6.

FIG. 7 illustrates steps of a method that would be performed by elements of an IP telephony system to accomplish methods as discussed above in connection with FIG. 3, where a user is allowed to control how a new telephony communication is setup and conducted. In particular, this method covers a situation where a user wishes to have a requested telephony communication setup through an alternate telephony system, other than the IP telephony system which initially receives a telephony communication setup request from a calling party.

The method 700 begins and proceeds to step S702 where a communication setup unit 402 of an IP telephony system 120 receives a telephony communication setup request from a calling party that wishes to setup a telephony communication with a user or customer of the IP telephony system. The telephony communication setup request could be directed to a telephone number that the IP telephony system 120 assigned to a user's IP telephony device. Alternatively, the telephony communication setup request could identify the user in some other fashion.

In step S704, the IP telephony communication setup unit 404 sends an IP telephony communication setup request to the user's IP telephony device via a data network, such as the Internet. Note, in some instances, the user may have multiple IP telephony devices that are registered with the IP telephony system. In that instance, the IP telephony communication setup request may be sent to all of the registered IP telephony devices substantially simultaneously, or the IP telephony communication setup request may be sent to each of the user's IP telephony devices in a sequential fashion until one of the IP telephony devices responds.

If no IP telephony device for the user is currently online and registered with the IP telephony system, the IP telephony system may first take steps to cause one or more of the user's IP telephony devices to register with the IP telephony system. This could include causing a push notification to be sent to one or more of the user's IP telephony devices, where the push notification is designed to cause the IP telephony device to register with the IP telephony system. Of course, one or more of the user's IP telephony devices could be caused to register with the IP telephony system in some other fashion. Once the user's IP telephony device has registered with the IP telephony system, the IP telephony communication setup request would be sent to the user's IP telephony device.

As mentioned above in connection with FIG. 3, once the user's IP telephony device has received the IP telephony communication setup request, the user's IP telephony device may cause a query to be presented to the user, the query asking the user how the user wishes to handle the telephony communication. If the user indicates that he wishes to receive the telephony communication as an IP telephony communication that is carried over a data network, the user's IP telephony device and the IP telephony system 120 would interact to setup and conduct the telephony communication as an IP telephony communication. If the user wishes to decline the requested telephony communication, the user's IP telephony device would so inform the IP telephony system 120, and the IP telephony system 120 would inform the calling party that the requested telephony communication cannot be setup at this time.

However, the method illustrated in FIG. 7 covers a situation where the user wishes to have the telephony communication connected to his IP telephony device, or an alternate telephony device, via an alternate telephony system. Thus, when the user provides this instruction, the user's IP telephony device sends a communication to the communication setup unit 402 of the IP telephony system 120 indicating that the telephony communication is to be setup through an alternate telephony system. This communication may also indicate that the telephony communication should be setup to an alternate telephony device.

Returning now to the steps illustrated in FIG. 7, in step S706 the communication setup unit 402 of the IP telephony system 120 receives a communication from the user's IP telephony device indicating that the user wishes for the telephony communication to be setup through an alternate telephony system, and possibly also to an alternate telephony device. In step S708, the IP telephony system then facilitates the setup of the telephony communication in the manner instructed by the user.

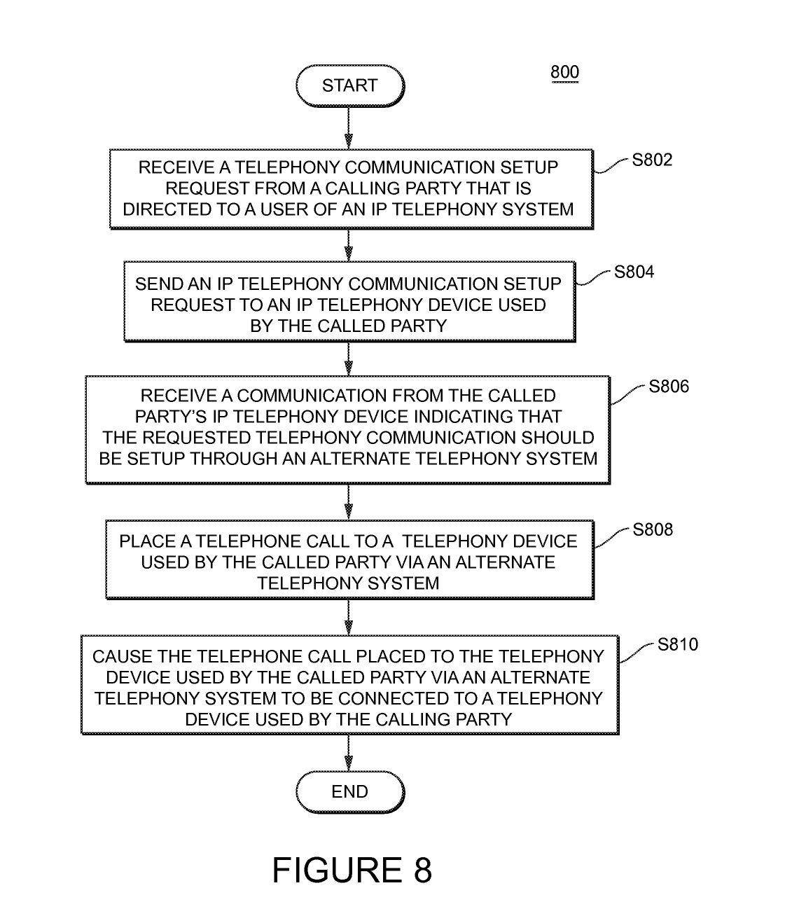

The facilitating step performed in step S708 could take several different forms, depending on how the IP telephony system 120 is configured, and depending on how the user's telephony device is configured. Several of those alternatives are explained below in connection with FIGS. 8-10, which illustrate three alternatives for the facilitating step. However, it is to be understood, and other possible ways of performing the facilitating step S708 may also be possible. Thus, performance of the facilitating step S708 is not to be limited to only those alternatives discussed herein, and illustrated in FIGS. 8-10.

FIG. 8 illustrates a method similar to the one discussed above in connection with FIG. 7, but where the requested telephony communication is setup by having the IP telephony system 120 place an outgoing call to a telephony device used by the called party. The method 800 begins and proceeds to step S802 where the communication setup unit 402 of an IP telephony system 120 receives a telephony communication setup request from a calling party that wishes to setup a telephony communication with a user or customer of the IP telephony system. In step S804, the IP telephony communication setup unit 404 sends an IP telephony communication setup request to the user's IP telephony device via a data network, such as the Internet. In step S806 the communication setup unit 402 of the IP telephony system 120 receives a communication from the user's IP telephony device indicating that the user wishes for the telephony communication to be setup through an alternate telephony system, and possibly also to an alternate telephony device.

In step S808, an outgoing call setup unit 407 places an outgoing call to a telephony device used by the called party via an alternate telephony system. For example, if the called party's IP telephony device is an IP telephony software application 604 running on a user telephony device 600 as illustrated in FIG. 6, the user telephony device 600 would also have separate cellular telephony capabilities. In other words, the user telephony device 600 would also receive its native telephony service from a cellular telephony system. This means that the cellular telephony system would have assigned a telephone number to the user telephony device 600. Thus, the outgoing call setup unit 407 of the IP telephony system could place an outgoing call to the telephone number assigned by the cellular telephony system in step S808. As a result, a new cellular telephony communication would be established to the user telephony device 600 via the cellular telephony system—which in this case is the alternate telephony system.

In step S810, the communication setup unit 402 of the IP telephony system bridges the incoming telephony communication received from the calling party to the outgoing telephony communication established to the called party's telephony device 600 via the cellular telephony system. The method then ends.

In an alternate scenario, in step S806 of the method illustrated in FIG. 8, the communication received from the called party's IP telephony device may indicate that the requested telephony communication is to be setup through an alternate telephony system, and to an alternate telephony device that is also available to the called party. For example, the communication received from the called party's IP telephony device may indicate that the requested telephony communication is to be setup to a separate cellular telephone or a separate analog telephone that is available to the called party. In such a situation, the communication received from the called party's IP telephony device could include a telephone number associated with the alternate telephony device, or some other information identifying the alternate telephony device.

Under these circumstances, in step S808, the outgoing call setup unit 407 of the IP telephony system 120 places an outgoing call to the alternate telephony device that is identified in the communication received from the called party's telephony device. Note, the alternate telephony device to which the outgoing call is placed receives its telephony service from an alternate telephony system. In step S810, the communication setup unit 402 then bridges the incoming telephony communication received from the calling party to the outgoing call placed to the alternate telephony device via an alternate telephony system, and the method then ends.

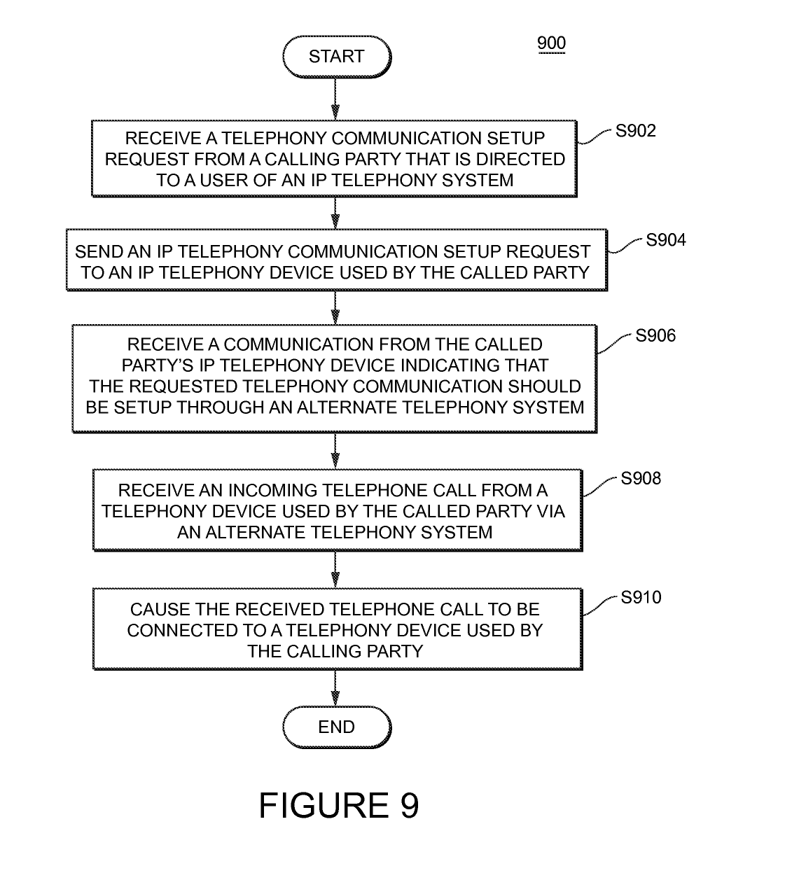

FIG. 9 also illustrates a method similar to the one discussed above in connection with FIG. 7, but where the requested telephony communication is setup by having the called party's IP telephony device cause a telephone call to be placed to the IP telephony system 120 through an alternate telephony system. The method 900 begins and proceeds to step S902 where the communication setup unit 402 of an IP telephony system 120 receives a telephony communication setup request from a calling party that wishes to setup a telephony communication with a user or customer of the IP telephony system. In step S904, the IP telephony communication setup unit 404 sends an IP telephony communication setup request to the user's IP telephony device via a data network, such as the Internet. In step S906 the communication setup unit 402 of the IP telephony system 120 receives a communication from the user's IP telephony device indicating that the user wishes for the telephony communication to be setup through an alternate telephony system. This could be a communication indicating that the IP telephony device should expect to receive an incoming call that is associated with the call from the calling party from one of the user's telephony devices, that incoming call being placed through an alternate telephony system.

Once the called party's IP telephony device has sent the communication received in step S906, the called party's IP telephony device will arrange for an outgoing call to be placed via an alternate telephony system. For example, if the called party's IP telephony device is an IP telephony software application 604 running on a user telephony device 600 as illustrated in FIG. 6, the user telephony device 600 would also have separate cellular telephony capabilities. The cellular communication instruction unit 612 of the IP telephony software application 602 would instruct the cellular telephony communication setup unit 602 to setup an outgoing cellular telephony communication that is directed to an access telephone number of the IP telephony system 120. That access telephone number could be provided to the IP telephony software application 604 in a communication received from the IP telephony system during the attempted setup of the initial IP telephony communication. Alternatively, this access telephone number could be provided to the called party's user telephony device in some other fashion, or it could be provided to the IP telephony software application as provisioning or configuration information.

Returning now to the method illustrated in FIG. 9, in step S908 the incoming call receiving unit 406 of the communication setup unit 402 receives the call placed by the called party's telephony device. As noted, this incoming call would be received on a line corresponding to the access telephone number that was dialed by the called party's telephony device. This incoming call would be implemented through the cellular telephony system that provides the called party's telephone device with its native telephony service—which in this case is the alternate telephony system.

In step S910, the communication setup unit 402 bridges the incoming telephony communication received from the calling party to the incoming call received from the called party's telephony device, which was received on a line corresponding to the access telephone number. As a result, the calling party is connected to the called party's telephony device via the cellular telephony system that provides the called party's telephony device with its native telephony service.

In some instances, when the incoming call receiving unit 406 receives an incoming call on a line corresponding to the access telephone number dialed by the called party's telephony device, the incoming call receiving unit 406 checks caller ID information associated with the incoming telephone call. This would allow the incoming call receiving unit 406 to identify the called party's telephony device based on the telephone number provided in the caller ID information. The communication setup unit 402 would then be able to associate the incoming call received from the called party's telephony device with the correct incoming telephony communication from a calling party so the correct bridging action can occur to connect the calling party with the proper called party.

In alternate embodiments, the IP telephony system may maintain multiple access telephone numbers for use in such a method. A communication passing from the IP telephony system to the called party's telephony device will inform the called party's telephony device of which access telephone number to use for purposes of setting up the telephony communication via an alternate telephony system. The called party's telephony device then sets up an outgoing call to the IP telephony system using the provided access telephone number when the user instructs that the telephony communication is to be setup through an alternate telephony system. Under these circumstances, it may not be necessary for the incoming call receiving unit 406 to check the caller ID information in order to identify the called party's telephony device. Instead, simply knowing the access telephone number of the line on which the incoming call from the called party's telephony device is received may be sufficient to identify the called party's telephony device. Optionally, receiving an incoming call on a particular line shortly after the access telephone number of that line was provided to the called party's telephony device may help to determine which called party's telephony device is making the call. Thus, it would be possible to match up the incoming call received from the called party's telephony device to the incoming telephony communication from a calling party for purposes of bridging the appropriate parties together.

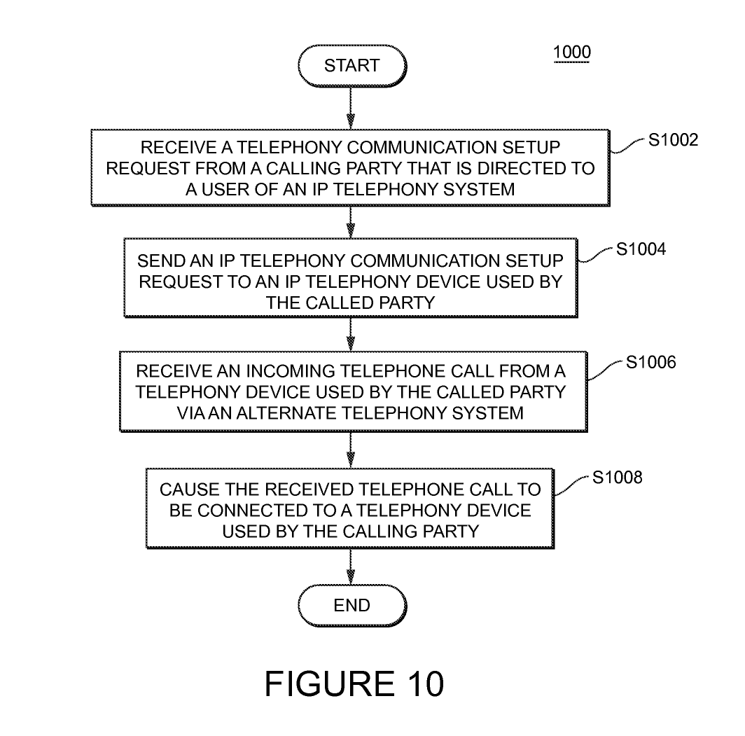

FIG. 10 illustrates a method similar to the one described above in connection with FIG. 9. However, in this method, when the called party determines that the telephony communication is to be setup through an alternate telephony system, the called party's telephony device makes no attempt to send a communication to this effect back to the IP telephony system. Instead, the called party's telephony device simply places a call to an access telephone number maintained by the IP telephony system.

The method 1000 begins and proceeds to step S1002 where the communication setup unit 402 of an IP telephony system 120 receives a telephony communication setup request from a calling party that wishes to setup a telephony communication with a user or customer of the IP telephony system. In step S1004, the IP telephony communication setup unit 404 sends an IP telephony communication setup request to the user's IP telephony device via a data network, such as the Internet.

As mentioned above, the called party's IP telephony device then queries the called party to determine how the called party would like to have the telephony communication setup. The called party would instruct that the telephony communication is to be setup via an alternate telephony system. At that point, the called party's telephony device immediately places an outgoing telephone call to an access telephone number maintained by the IP telephony system via an alternate telephony system, such as a cellular telephony system. The called party's telephony device could have received the access telephone number as part of the initial IP telephony communication setup request sent in step S1004. Alternatively, the called party's telephony device could have received the access telephone number in some other fashion.

Returning now to the method illustrated in FIG. 10, in step S1006 the incoming call receiving unit 406 receives the call placed by the called party's telephony device. The incoming call receiving unit 406 may check caller ID information that is provided as part of this incoming call in order to identify the called party's telephony device. Alternatively, the line on which the incoming call is received may provide an indication of the identity of the called party's telephony device, as described above. Then, in step S1008, the communication setup unit 402 of the IP telephony system bridges the incoming call received from the called party's telephony device to the incoming telephony communication received from the calling party in order to connect the calling party to the called party. The method then ends.

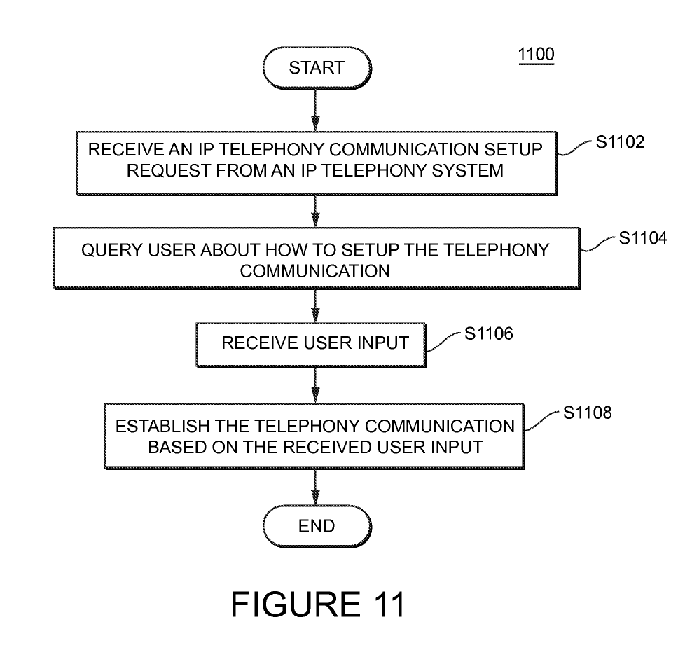

The methods described above in connection with FIGS. 7-10 are performed by elements of an IP telephony system as part of an overall process of allowing a called party to exert control over how an incoming telephony communication is established and conducted. FIGS. 11-13 will now be used to describe methods that are performed by elements of a user's telephony device to accomplish those same overall processes.

FIG. 11 illustrates a first method performed by elements of a user's telephony device to setup a new telephony communication. For purposes of facilitating the explanation, we will assume that the method is performed by elements of a user telephony device 600 like the one illustrated in FIG. 6, where an IP telephony software application 604 is loaded and running on the user telephony device 600. The IP telephony software application 604 is able to setup and conduct IP telephony communications via a data network, with the assistance of an IP telephony system 120. The user telephony device 600 also has a cellular telephony capability that makes it possible for the user telephony device to setup and conduct cellular telephony communications via a cellular telephony system.

Before the method illustrated in FIG. 11 begins, an IP telephony system will have received a telephony communication setup request from a calling party that is directed to a user or customer of the IP telephony system. The IP telephony system will have generated and sent an IP telephony communication setup request to the called party's telephony device via a data network, such as the Internet.

The method 1100 then begins and proceeds to step S1102 where the IP telephony communication setup request is received by an IP telephony software application 604 on a called party's telephony device 600. In step S1104, a user interaction unit 608 causes a query to be presented to the called party, the query asking how the called party wishes to handle the telephony communication setup request. In step S1106 the user interaction unit 608 receives and interprets user input provided by the called party in response to the query.

In some instances, the called party may wish to have the telephony communication setup as an IP telephony communication that traverses a data network. In other instances, the called party may wish to decline the telephony communication. However, in the method illustrated in FIG. 11, the input received from the called party in step S1106 indicates that the user wishes to setup the telephony communication via an alternate telephony system. In some instances, the input received in step S1106 may also indicate that the called party wishes to setup the telephony communication to an alternate telephony device.

In step S1108, elements of the called party's telephony device then act to establish the telephony communication in accordance with the user's input. The way in which step S1108 is performed could vary depending on the user input and the way in which the called party's telephony device is configured. Regardless, elements of the called party's telephony device will act to setup the telephony communication via an alternate telephony system, and possibly also to an alternate telephony device. The method then ends.

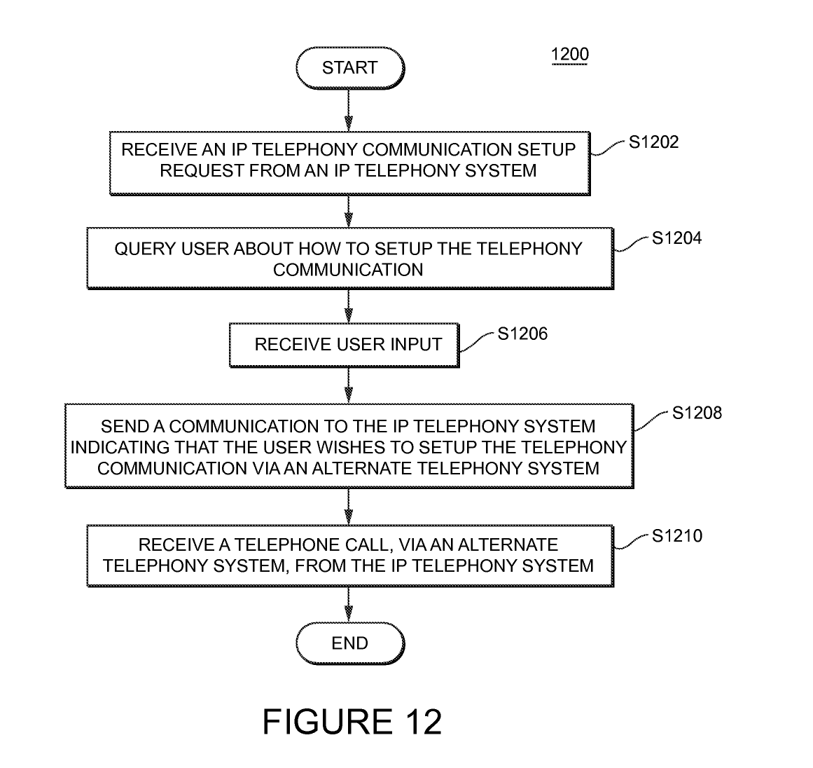

FIG. 12 illustrates steps of a method that is similar to the one discussed above in connection with FIG. 11, but where the telephony communication is setup via an alternate telephony system by having the IP telephony system place a call to the called party's telephony device via an alternate telephony system. The method 1200 begins and proceeds to step S1202 where the IP telephony software application on the called party's telephony device receives an IP telephony communication setup request from the IP telephony system. In step S1204, the user interaction unit 608 on the called party's telephony device causes a query to be posed to the called party, asking how the called party would like the telephony communication to be handled. In step S1206, input from the called party is received and interpreted by the user interaction unit 608. This input will indicate that the called party wishes to have the telephony communication setup via an alternate telephony system, and possibly also to an alternate telephony device.

In step S1208, an IP telephony system interaction unit 606 causes a communication to be sent to the IP telephony system via the data network, the communication indicating that the user wishes to have the telephony communication setup via an alternate telephony system. This communication may include information to help enable the IP telephony to set up the telephony communication via an alternate telephony system. Such information could include a telephone number or some other type of identifier that would allow the IP telephony system to place a call to the called party's telephony device via an alternate telephony system. For example, the communication sent to the IP telephony system could include a telephone number assigned to the called party's telephony device by a cellular telephony system that provides the called party's telephony device with its native cellular telephony service. In other instances, the IP telephony system may already be in possession of information that allows the IP telephony system to setup the telephony communication via an alternate telephony system.

In alternate embodiments, the communication sent to the IP telephony system in step S1208 may identify an alternate telephony device that is available to the called party, and on which the called party would like to receive the telephony communication. For example, the communication could provide a telephone number assigned to a cellular or analog telephone that is available to the called party.

Once the IP telephony system receives the communication sent in step S1208, an outgoing call setup unit 407 of the IP telephony system 120 places an outgoing telephone call to the called party via an alternate telephony system. As explained above, this could be an outgoing call via a cellular telephony system that is directed to the cellular capabilities of the called party's telephony device. Alternatively, this could be an outgoing call to a separate cellular or analog telephone available to the called party, and which will be routed through an alternate telephony system.

Returning to the method illustrated in FIG. 12, the method then proceeds to step S1210, where the called party receives the call placed by the outgoing call setup unit 407 of the IP telephony system via an alternate telephony system. This call could be received on the same called party telephony device that received the initial IP telephony communication setup request sent from the IP telephony system, or the call could be received an alternate telephony device available to the called party. The method then ends.

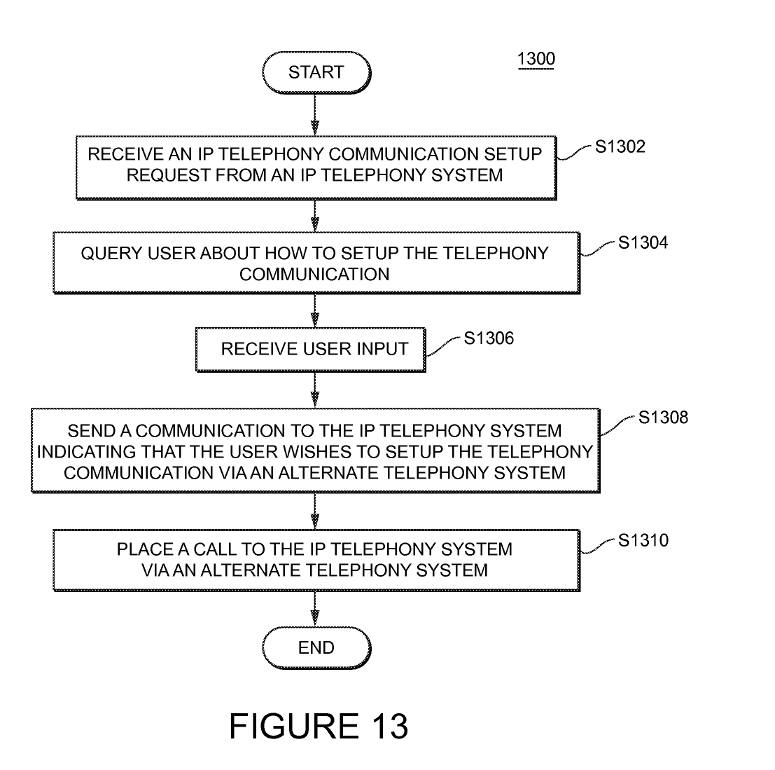

FIG. 13 also illustrates steps of a method that is similar to the one discussed above in connection with FIG. 11, but where the telephony communication is setup via an alternate telephony system by having the called party's telephony device place a call to the IP telephony system via the alternate telephony system. The method 1300 begins and proceeds to step S1302 where the IP telephony software application 604 on the called party's telephony device receives an IP telephony communication setup request from the IP telephony system. In step S1304, the user interaction unit 608 on the called party's telephony device causes a query to be posed to the called party, asking how the called party would like the telephony communication to be handled. In step S1306, input from the called party is received and interpreted by the user interaction unit 608. This input will indicate that the called party wishes to have the telephony communication setup via an alternate telephony system.

In step S1308, the IP telephony system interaction unit 606 sends a communication to the IP telephony system indicating that the called party wishes for the telephony communication to be setup through an alternate telephony system. Then, in step S1310, the cellular communication instruction unit 612 of the called party's telephony device causes an outgoing call to be placed to an access telephone number maintained by the IP telephony system by the cellular telephony communication setup unit 602 of the called party's telephony device. As explained in the discussion above, this access telephone number could be provided to the IP telephony software application 604 on the called party's telephony device as part of one of the communications sent to the called party's telephony device when the initial request to setup an IP telephony communication is received from the IP telephony system. In alternate embodiments, the IP telephony software application 604 may obtain this information as part of a provisioning or configuration process.

The outgoing call placed by the called party's telephony device would be answered by the incoming call receiving unit 406 of the IP telephony system. The IP telephony system then bridges the call received from the called party's telephony device to the incoming telephony communication received from the calling party, and the method ends.

The method described immediately above includes step S1308, where a communication is sent from the IP telephony system interaction unit 606 to the IP telephony system to inform the IP telephony system that the user wishes to setup the telephony communication via an alternate telephony system. In alternate embodiments, step S1308 may not be performed. In such alternate embodiments, once the user interaction unit 608 receives input from the called party indicating that the called party wishes to setup the telephony communication via an alternate telephony system in step S1306, the method proceeds immediately to step S1310 where an outgoing call is placed from the called party's telephony device to the IP telephony system via an alternate telephony system.

In the methods discussed above, a telephony communication that would otherwise be setup as an IP telephony communication that traverses a data network is instead setup for the called party via an alternate telephony system. This can be advantageous for multiple reasons.

In some cases, the called party may wish to move away from a wireless data access point that is providing his telephony device with access to the data network. By having a new incoming telephony communication setup over a cellular telephony system, rather than an IP telephony system, the user is freed to move away from the wireless access point.

In some cases, a user may know, or suspect, that if the new telephony communication is setup as an IP telephony communication that traverses the data network, the call quality may be poor. By causing the new incoming telephony communication to be setup over a cellular telephony system or an analog PSTN, rather than an IP telephony system, it may be possible to obtain a higher call quality. Of course, it may cost the called party more to have the incoming telephony communication routed in this fashion. But the increase in call quality may justify the increased cost.

In some cases, the called party may simply wish to have the new telephony communication setup over an alternate telephony device because the alternate telephony device offers functions or capabilities that are not provided by the called party's IP telephony device. For example, the called party may wish to have the incoming call directed to an analog or cellular telephony device, rather than the IP telephony device, because the analog or cellular telephony device provides speakerphone capabilities, or the ability to conference in additional people once the initial telephone call has been established between the calling and called parties. Having the telephony communication setup to an alternate telephony device may also require that the telephony communication be routed over an alternate telephony system that provides the alternate telephony device with its telephony service. Thus, the decision to route the new incoming telephony communication over an alternate telephony system may simply be a byproduct or consequence of wanting to conduct the telephony communication with an alternate telephony device.

In many of the foregoing descriptions, a software application running on a telephony device performs various functions. In alternate embodiments, a browser running on the telephony device may access a software application that is running on some other device via a data network connection. For example, the software application could be running on a remote server that is accessible via a data network connection. The software application running elsewhere, and accessible via a browser on the telephony device may provide all of the same functionality as an application running on the telephony device itself. Thus, any references in the foregoing description and the following claims to an application running on a telephony device are intended to also encompass embodiments and implementations where a browser running on a telephony device accesses a software application running elsewhere via a data network.

Also, although many of the examples provided about related to telephony communications, those telephony communications could be audio or video calls, or other forms of telephony communications. The methods and techniques described above could be used to enable many different types of communications. Thus, the foregoing references to calls or telephony communications should in no way be considered limiting.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method, performed by one or more elements of an Internet protocol (IP) telephony system, for setting up a telephony communication to a user telephony device, comprising:
receiving a telephony communication setup request from a calling party that is directed to a called party;
sending an IP telephony communication setup request to a receiving telephony device associated with the called party via a data network;
receiving a communication from the receiving telephony device to which the IP telephony communication setup request was sent, the communication indicating that the called party would prefer to setup the telephony communication via an alternate telephony system; and
facilitating the setup of the telephony communication to a participating telephony device associated with the called party via an alternate telephony system.

2. The method of claim 1, wherein facilitating the setup of the telephony communication to a participating telephony device associated with the called party via an alternate telephony system comprises:
placing a telephone call to the participating telephony device associated with the called party via an alternate telephony system; and
connecting the calling party to the participating telephony device associated with the called party via the alternate telephony system.

3. The method of claim 2, wherein placing a telephone call comprises placing a telephone call over at least one of a cellular telephony system or a PSTN telephony system.

4. The method of claim 2, wherein the receiving telephony device and the participating telephony device are the same telephony device.

5. The method of claim 2, wherein the receiving telephony device is different from the participating telephony device.

6. The method of claim 5, wherein the communication received from the receiving telephony device includes information identifying the participating telephony device.

7. The method of claim 1, wherein facilitating the setup of the telephony communication to a participating telephony device associated with the called party via an alternate telephony system comprises:
receiving, via an alternate telephony system, an incoming telephone call from the receiving telephony device to which the IP telephony communication setup request was sent; and
connecting the calling party to the receiving telephony device via the alternate telephony system.

8. The method of claim 7, wherein receiving an incoming telephone call comprises receiving an incoming telephone call via a cellular telephony system.

9. The method of claim 7, wherein the IP telephony communication setup request sent to the receiving telephony device includes a telephone number, and wherein receiving an incoming telephone call comprises receiving an incoming telephone call that was directed to the telephone number.

10. The method of claim 7, wherein the calling party is connected to the receiving telephony device only if a telephone number in caller ID information associated with the incoming telephone call matches a telephone number assigned to the receiving telephone device.

11. The method of claim 1, wherein receiving a communication from the receiving telephony device to which the IP telephony communication setup request was sent comprises receiving, via an alternate telephony system, an incoming telephone call from the receiving telephony device.

12. The method of claim 11, wherein the facilitating step comprises causing the incoming telephone call received via the alternate telephony system to be connected to a telephony device used by the calling party.

13. A system for setting up a telephony communication to a user telephony device, comprising:
means for receiving a telephony communication setup request from a calling party that is directed to a called party;
means for sending an Internet protocol (IP) telephony communication setup request to a receiving telephony device associated with the called party via a data network;
means for receiving a communication from the receiving telephony device to which the IP telephony communication setup request was sent, the communication indicating that the called party would prefer to setup the telephony communication via an alternate telephony system; and
means for facilitating the setup of the telephony communication to a participating telephony device associated with the called party via an alternate telephony system.

14. A system for setting up a telephony communication to a user telephony device, comprising:
a communication setup unit that receives a telephony communication setup request from a calling party that is directed to a called party, the communication setup unit including:
an IP telephony communication setup unit that sends an IP telephony communication setup request to a receiving telephony device associated with the called party via a data network, and that receives a communication from the receiving telephony device to which the IP telephony communication setup request was sent, the communication indicating that the called party would prefer to setup the telephony communication via an alternate telephony system,
wherein the communication setup unit facilitates the setup of the telephony communication to a participating telephony device associated with the called party via an alternate telephony system.

15. The system of claim 14, wherein the communication setup unit also includes an outgoing call setup unit that facilitates the setup of the telephony communication to a participating telephony device associated with the called party via an alternate telephony system by placing a telephone call to the participating telephony device associated with the called party via an alternate telephony system, and wherein the communication setup unit connects the calling party to the participating telephony device associated with the called party via the alternate telephony system.

16. The system of claim 15, wherein the outgoing call setup unit places a telephone call over at least one of a cellular telephony system or a PSTN telephony system.

17. The system of claim 15, wherein the receiving telephony device and the participating telephony device are the same telephony device.

18. The system of claim 15, wherein the receiving telephony device is different from the participating telephony device.

19. The system of claim 18, wherein the communication received from the receiving telephony device includes information identifying the participating telephony device.

20. The system of claim 14, wherein the communication setup unit includes an incoming call receiving unit that receives, via an alternate telephony system, an incoming telephone call from the receiving telephony device to which the IP telephony communication setup request was sent, and wherein the communication setup unit connects the calling party to the receiving telephony device via the alternate telephony system.

21. The system of claim 20, wherein the incoming call receiving unit receives an incoming telephone call via a cellular telephony system.

22. The system of claim 20, wherein the IP telephony communication setup request sent to the receiving telephony device includes a telephone number, and wherein the incoming call receiving unit receives an incoming telephone call that was directed to the telephone number.

23. The system of claim 20, wherein the communication setup unit connects the calling party to the receiving telephony device only if a telephone number in caller ID information associated with the incoming telephone call received by the incoming call receiving unit matches a telephone number assigned to the receiving telephone device.

24. The system of claim 14, wherein receiving a communication from the receiving telephony device to which the IP telephony communication setup request was sent comprises the incoming call receiving unit receiving, via an alternate telephony system, an incoming telephone call from the receiving telephony device.
